(19) United States
(12) Patent Application Publication
(10) Pub. No.: US 2019/0272542 A1
(43) Pub. Date: Sep. 5, 2019

(54) System, Method, and Computer Program Product for Determining a Street Address Associated with an Account

(71) Applicant: Visa International Service Association, San Francisco, CA (US)

(72) Inventor: Justin Xavier Howe, San Francisco, CA (US)

(21) Appl. No.: 15/911,200

(22) Filed: Mar. 5, 2018

(51) Int. Cl. G06Q 20/40

(52) U.S. Cl. CPC G06Q 20/401

(57) ABSTRACT

Provided is a method for determining a street address associated with an account. The method may include receiving address data associated with a street address of an account, determining whether the address data associated with the street address of the account includes a postal code, identifying a street name located within an area associated with the postal code of the street address based on determining that the address data associated with the street address of the account includes a postal code, determining at least one proposed street address based on the street name located within the area associated with the postal code of the street address, and assigning the account to a proposed street address of the at least one proposed street address based on a criteria associated with the proposed street address. A system and computer program product are also provided.

### BACKGROUND OF THE INVENTION

### 1. Field of the Invention

This invention relates generally to systems, devices, products, apparatus, and methods that are used for determining an address associated with an account and in one particular embodiment, to a system, product, and method for determining an address associated with an account of a user.

### 2. Technical Considerations

An Address Verification System (AVS) may be a system that is used to verify that a person conducting a payment transaction with a merchant involving an account is an account holder of the account. For example, the merchant may receive information associated with a street address of the account (e.g., a billing address of the account) from the person conducting the payment transaction with the merchant and the merchant may communicate the information associated with the street address to an AVS. In some instances, the AVS may receive the information associated with the street address and the AVS may verify that the person conducting the payment transaction is an account holder of the account by comparing the information associated with the street address received from the merchant to information associated with a street address of the account that is stored by an issuer and/or a transaction service provider associated with the account. The AVS may communicate a code to the merchant, where the code is associated with a determination of whether the information associated with the street address received from the merchant corresponds to information associated with the street address that is stored by the issuer and/or the transaction service provider associated with the account.

However, in some instances the information associated with the street address of the account received from the person associated with the account and/or received from the merchant may not include a correct street address of the account and/or a complete street address of the account. In this way, the AVS may not be able to verify that the person conducting the payment transaction with the merchant involving the account is an account holder of the account. Additionally, the correct street address of the account and/or the complete street address of the account may not be able to be determined based on the code communicated by the AVS and the information associated with the street address received from the person and/or received from the merchant.

### SUMMARY OF THE INVENTION

Accordingly, systems, devices, products, apparatus, and/or methods for determining a street address associated with an account are disclosed that overcome some or all of the deficiencies of the prior art.

According to a non-limiting embodiment, provided is a method for determining a street address associated with an account. The method comprises receiving, with at least one processor, address data associated with a street address of an account, wherein the address data comprises a street number of the street address and a postal code of the street address; determining, with at least one processor, whether the address data associated with the street address of the account includes a postal code; identifying, with at least one processor, a street name located within an area associated with the postal code of the street address based on determining that the address data associated with the street address of the account includes a postal code; determining, with at least one processor, at least one proposed street address based on the street name located within the area associated with the postal code of the street address; and assigning, with at least one processor, the account to a proposed street address of the at least one proposed street address based on a criteria associated with the proposed street address.

According to another non-limiting embodiment, provided is a system for determining a street address associated with an account. The system comprises at least one processor programmed or configured to receive address data associated with a street address of an account, wherein the address data comprises a street number of the street address and a postal code of the street address; determine whether the address data associated with the street address of the account includes a postal code; identify a street name located within an area associated with the postal code of the street address based on determining that the address data associated with the street address of the account includes a postal code; determine at least one proposed street address based on the street name located within the area associated with the postal code of the street address; and assign the account to a proposed street address of the at least one proposed street address.

According to a further non-limiting embodiment, provided is a computer program product for determining a dominant account profile of an account. The computer program product comprises at least one non-transitory computer-readable medium including one or more instructions that, when executed by at least one processor, cause the at least one processor to receive address data associated with a street address of an account and AVS code data associated with an AVS code; determine whether the address data associated with the street address of the account includes a postal code based on the AVS code data associated with the AVS code; determine a postal code of the street address of the account based on determining that the address data associated with the street address of the account includes a postal code; identify a street name located within an area associated with the postal code of the street address based on determining the postal code of the street address of the account; determine a plurality of proposed street addresses based on the street name located within the area associated with the postal code of the street address; and assign the account to a proposed street address of the plurality of proposed street addresses based on the proposed street address of the plurality of proposed street addresses being associated with a residential household.

Further embodiments or aspects are set forth in the following numbered clauses:

Clause 1: A method for determining a street address associated with an account, comprising: receiving, with at least one processor, address data associated with a street address of an account, wherein the address data comprises a street number of the street address and a postal code of the street address; determining, with at least one processor, whether the address data associated with the street address of the account includes a postal code; identifying, with at least one processor, a street name located within an area associated with the postal code of the street address based on determining that the address data associated with the street address of the account includes a postal code; determining, with at least one processor, at least one proposed street address based on the street name located within the area associated with the postal code of the street address; and assigning, with at least one processor, the account to a proposed street address of the at least one proposed street address based on a criteria associated with the proposed street address.

Clause 2: The method of clause 1, further comprising: receiving address verification system (AVS) code data associated with an AVS code, wherein the AVS code is associated with an online payment transaction involving the account; and wherein determining whether the address data associated with the street address of the account includes a postal code comprises: determining whether the AVS code data associated with the AVS code indicates that the address data associated with the street address of the account includes a postal code.

Clause 3: The method of clauses 1 or 2, wherein identifying the street name located within the area associated with the postal code of the street address comprises: identifying the street name located within the area associated with the postal code of the street address based on determining that the AVS code data associated with the AVS code indicates that the address data associated with the street address of the account includes a postal code.

Clause 4: The method of any of clauses 1-3, further comprising: communicating assignment data associated with an assignment of the account to the proposed street address based on assigning the account to the proposed street address.

Clause 5: The method of any of clauses 1-4, wherein assigning the account to the proposed street address comprises: assigning the account to the proposed street address of the at least one proposed street address based on a number of residential households associated with the proposed street address.

Clause 6: The method of any of clauses 1-5, wherein assigning the account to the proposed street address of the at least one proposed street address based on the criteria associated with the proposed street address comprises: determining whether the proposed street address of the at least one proposed street address is associated with a residential household; and assigning the account to the proposed street address of the at least one proposed street address based on determining that the proposed street address of the at least one proposed street address is associated with a residential household.

Clause 7: The method of any of clauses 1-6, wherein the at least one proposed street address are a plurality of proposed street addresses and wherein assigning the account to the proposed street address of the plurality of proposed street addresses comprises: assigning the account to the proposed street address of the plurality of proposed street addresses based on the proposed street address being located within a predetermined distance of a location of a merchant.

Clause 8: A system for determining a street address associated with an account comprising: at least one processor programmed or configured to: receive address data associated with a street address of an account, wherein the address data comprises a street number of the street address and a postal code of the street address; determine whether the address data associated with the street address of the account includes a postal code; identify a street name located within an area associated with the postal code of the street address based on determining that the address data associated with the street address of the account includes a postal code; determine at least one proposed street address based on the street name located within the area associated with the postal code of the street address; and assign the account to a proposed street address of the at least one proposed street address.

Clause 9: The system of clause 8, wherein the at least one processor is further programmed or configured to: determine a distance between a location of a merchant and each of the at least one proposed street address; and assigning the account to the proposed street address of the at least one proposed street address based on the distance between the location of the merchant and the proposed street address satisfying a threshold value of a distance.

Clause 10: The system of clauses 8 or 9, wherein the at least one processor is further programmed or configured to: receive address verification system (AVS) code data associated with an AVS code, wherein the AVS code is associated with an online payment transaction involving the account; and wherein, when determining whether the address data associated with the street address of the account includes a postal code, the at least one processor is programmed or configured to: determine whether the AVS code data associated with the AVS code indicates that the address data associated with the street address of the account includes a postal code.

Clause 11: The system of any of clauses 8-10, wherein, when identifying the street name located within the area associated with the postal code of the street address, the at least one processor is programmed or configured to: identify the street name located within the area associated with the postal code of the street address based on determining that the AVS code data associated with the AVS code indicates that the address data associated with the street address of the account includes a postal code.

Clause 12: The system of any of clauses 8-11, wherein the at least one processor is further programmed or configured to: determine a nine-digit postal code associated with the proposed street address based on assigning the account to the proposed street address; and communicate data associated with the nine-digit postal code to a computing device.

Clause 13: The system of any of clauses 8-12, wherein assigning the account to the proposed street address comprises: assigning the account to the proposed street address of the at least one proposed street address based on a number of residential households associated with the proposed street address.

Clause 14: The system of any of clauses 8-13, wherein assigning the account to the proposed street address of the at least one proposed street address comprises: determining whether the proposed street address of the at least one proposed street address is associated with a residential household; and assigning the account to the proposed street address of the at least one proposed street address based on determining that the proposed street address of the at least one proposed street address is associated with a residential household.

Clause 15: The system of any of clauses 8-14, wherein, when assigning the account to the proposed street address of the plurality of proposed street addresses, the at least one processor is programmed or configured to: assign the account to the proposed street address of the plurality of proposed street addresses based on the proposed street address being located within a predetermined distance of a location of a merchant.

Clause 16: A computer program product for determining a dominant account profile of an account, the computer program product comprising at least one non-transitory computer-readable medium including one or more instructions that, when executed by at least one processor, cause the at least one processor to: receive address data associated with a street address of an account and AVS code data associated with an AVS code; determine whether the address data associated with the street address of the account includes a postal code based on the AVS code data associated with the AVS code; determine a postal code of the street address of the account based on determining that the address data associated with the street address of the account includes a postal code; identify a street name located within an area associated with the postal code of the street address based on determining the postal code of the street address of the account; determine a plurality of proposed street addresses based on the street name located within the area associated with the postal code of the street address; and assign the account to a proposed street address of the plurality of proposed street addresses based on the proposed street address of the plurality of proposed street addresses being associated with a residential household.

Clause 17: The computer program product of clause 16, wherein the one or more instructions further cause the at least one processor to: determine a distance between a location of a merchant and each of the plurality of proposed street addresses; and assigning the account to the proposed street address of the plurality of proposed street addresses based on the distance between the location of the merchant and the proposed street address that satisfies a threshold value of a distance.

Clause 18: The computer program product of clauses 16 or 17, wherein the one or more instructions further cause the at least one processor to: determine whether the AVS code data associated with the AVS code indicates that the address data associated with the street address of the account includes a postal code.

Clause 19: The computer program product of any of clauses 16-18, wherein the one or more instructions that cause the at least one processor to identify the street name located within the area associated with the postal code of the street address, cause the at least one processor to: identify the street name located within the area associated with the postal code of the street address based on determining that the AVS code data associated with the AVS code indicates that the address data associated with the street address of the account includes a postal code.

Clause 20: The computer program product of any of clauses 16-19, wherein the one or more instructions further cause the at least one processor to: determine a nine-digit postal code associated with the proposed street address based on assigning the account to the proposed street address; and communicate data associated with the nine-digit postal code to a computing device.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a diagram of a non-limiting embodiment of an environment in which systems, devices, products, apparatus, and/or methods, described herein, may be implemented according to the principles of the present invention;

FIG. 2 is a diagram of a non-limiting embodiment of components of one or more devices of FIG. 1;

FIG. 3 is a flowchart of a non-limiting embodiment of a process for determining a street address associated with an account; and

FIGS. 4A-4C are diagrams of an implementation of a non-limiting embodiment of the process shown in FIG. 3.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

Some non-limiting embodiments are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

As used herein, the term “communicate” may refer to the reception, receipt, transmission, transfer, provision, and/or the like of information (e.g., data, signals, messages, instructions, commands, and/or the like). As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments, a message may refer to a packet (e.g., a data packet, a network packet, and/or the like) that includes data.

As used herein, the term “transaction service provider” may refer to an entity that receives transaction authorization requests from merchants or other entities and provides guarantees of payment, in some cases through an agreement between the transaction service provider and an issuer. For example, a transaction service provider may include a payment network, such as Visa®, MasterCard®, American Express®, or any other entity that processes transactions. As used herein “transaction service provider system” may refer to one or more systems operated by or operated on behalf of a transaction service provider, such as a transaction service provider system executing one or more software applications associated with the transaction service provider. In some non-limiting embodiments, a transaction service provider system may include one or more servers operated by or operated on behalf of a transaction service provider.

As used herein, the term “issuer” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions). For example, an issuer may provide an account identifier, such as a personal account number (PAN), to a user that uniquely identifies one or more accounts associated with the user. The account identifier may be used by the user to conduct a payment transaction. In some non-limiting embodiments, the account identifier may be embodied on a portable financial device, such as a physical financial instrument (e.g., a payment card) and/or may be electronic and used for electronic payments. In some non-limiting embodiments, an issuer may be associated with a bank identification number (BIN) that uniquely identifies the issuer. As used herein “issuer system” may refer to one or more systems operated by or operated on behalf of an issuer. For example, an issuer system may refer to a server executing one or more software applications associated with the issuer. In some non-limiting embodiments, an issuer system may include one or more servers (e.g., one or more authorization servers) for authorizing a payment transaction.

As used herein, the term “merchant” may refer to one or more entities (e.g., one or more operators of retail businesses, one or more retailers, and/or the like) that provide goods and/or services to a user based on a payment transaction between the one or more entities and the user. As used herein “merchant system” may refer to one or more systems operated by or operated on behalf of a merchant, such as a server executing one or more software applications associated with the merchant.

As used herein, the term “account identifier” may refer to one or more types of identifiers associated with an account (e.g., a unique identifier of an account, an account number, a PAN, a card number, a payment card number, a token, and/or the like) of a user. In some non-limiting embodiments, an issuer may provide an account identifier to a user that uniquely identifies one or more accounts associated with that user. In some non-limiting embodiments, an account identifier may be embodied on a physical financial instrument (e.g., a portable financial device, a payment card, a credit card, a debit card, and/or the like) and/or may be electronic information communicated to the user that the user may use for electronic payment transactions. In some non-limiting embodiments, an account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten by the user, stolen from the user, and/or the like, a supplemental account identifier may be provided to the user. In some non-limiting embodiments, an account identifier may be directly or indirectly associated with an issuer such that an account identifier may be a token that maps to a PAN or other type of identifier. Account identifiers may be alphanumeric, any combination of characters and/or symbols, and/or the like.

As used herein, the term “token” may refer to an identifier that is used as a substitute or replacement identifier for an account identifier, such as a PAN. A token may be used as a substitute or replacement identifier for an original account identifier, such as a PAN. Tokens may be associated with a PAN or other original account identifier in one or more data structures (e.g., one or more databases and/or the like) such that they may be used to conduct a transaction without directly using the original account identifier. In some non-limiting embodiments, an original account identifier, such as a PAN, may be associated with a plurality of tokens for different individuals or purposes. In some non-limiting embodiments, tokens may be associated with a PAN or other account identifiers in one or more data structures such that they can be used to conduct a transaction without directly using the account identifier, such as a PAN. In some examples, an account identifier, such as a PAN, may be associated with a plurality of tokens for different uses or different purposes.

As used herein, the term “portable financial device” may refer to a payment card, such as a credit card, a debit card, a charge card, and/or the like, a gift card, a smartcard, a payroll card, and/or the like, associated with an account identifier of an account. In some non-limiting embodiments, the portable financial device may include volatile or non-volatile memory to store information (e.g., an account identifier, a name of the account holder, and/or the like).

As used herein, the term “client device” may refer to one or more devices (e.g., client-side devices) or one or more systems (e.g., client-side systems), which are remote from a server, used to access a functionality provided by the server. For example, a client device may include one or more computing devices (e.g., one or more computers, computing machines, processors, electronic computers, information processing systems, and/or the like), portable computers, tablet computers, cellular phones, smartphones, wearable devices (e.g., watches, glasses, lenses, clothing, and/or the like), personal digital assistants (PDAs), and/or the like.

As used herein, the term “server” may refer to one or more devices that provide a functionality to one or more devices (e.g., one or more client devices) via a network (e.g., a public network, a private network, the Internet, and/or the like). For example, a server may include one or more computing devices.

As used herein, the term “system” may refer to one or more devices, such as one or more processors, servers, client devices, computing devices that include software applications, and/or the like.

In some non-limiting embodiments, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments of the present invention are directed to systems, methods, and computer program products for determining a dominant account profile of an account. In some non-limiting embodiments, a method may include receiving address data associated with a street address of an account. In some non-limiting embodiments, the address data comprises a street number of the street address, a street name of the street address, and a postal code of the street address. The method may further include determining whether the address data associated with the street address of the account includes a postal code, identifying a street name located within an area associated with the postal code of the street address based on determining that the address data associated with the street address of the account includes a postal code, determining at least one proposed street address based on the street name located within the area associated with the postal code of the street address, and assigning the account to a proposed street address of the at least one proposed street address based on a criteria associated with the proposed street address.

In this way, the address data associated with the street address of the account may be determined to include a correct street address of the account. In addition, the street address of the account may include a correct street address of the account. Additionally, the correct street address of the account may be able to be determined based on the address data associated with the street address of the account.

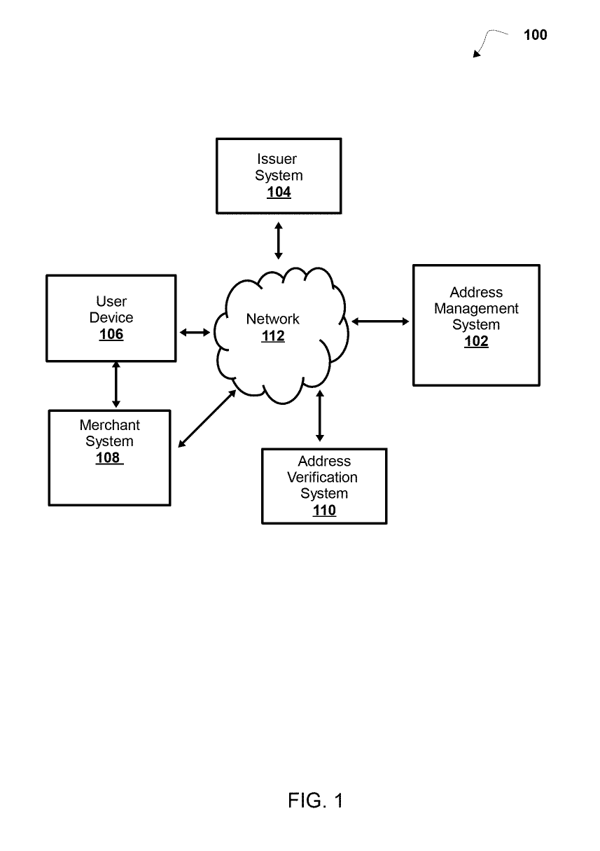

Referring now to FIG. 1, FIG. 1 is a diagram of an example environment 100 in which devices, systems, and/or methods, described herein, may be implemented. As shown in FIG. 1, environment 100 includes address management system 102, an issuer system 104, a user device 106, a merchant system 108, address verification system 110, and a network 112. Address management system 102, issuer system 104, user device 106, merchant system 108, and/or address verification system 110 may interconnect (e.g., establish a connection to communicate) via wired connections, wireless connections, or a combination of wired and wireless connections.

Address management system 102 may include one or more devices capable of receiving information from issuer system 104, user device 106, merchant system 108, and/or address verification system 110 via network 112 and/or communicating information to issuer system 104, user device 106, merchant system 108, and/or address verification system 110 via network 112. For example, address management system 102 may include one or more computing devices, such as a server (e.g., a transaction processing server), a group of servers, and/or other like devices. In some non-limiting embodiments, address management system 102 may be associated with a financial institution, a transaction service provider, and/or an issuer as described herein. For example, address management system 102 may be operated by a financial institution, a transaction service provider, and/or an issuer. In some non-limiting embodiments, address management system 102 may include address verification system 110. For example, address verification system 110 may be a component of address management system 102.

Issuer system 104 may include one or more devices capable of receiving information from address management system 102, user device 106, merchant system 108, and/or address verification system 110 via network 112 and/or communicating information to address management system 102, user device 106, merchant system 108, and/or address verification system 110 via network 112. For example, issuer system 104 may include one or more computing devices, such as a server, a group of servers, and/or other like devices. In some non-limiting embodiments, issuer system 104 may be associated with an issuer as described herein. For example, issuer system 104 may be associated with an issuer that issued a credit account, debit account, credit card, debit card, and/or the like to a user associated with user device 106.

User device 106 may include one or more devices capable of receiving information from address management system 102, issuer system 104, merchant system 108, and/or address verification system 110 via network 112 and/or communicating information to address management system 102, issuer system 104, merchant system 108, and/or address verification system 110 via network 112. For example, user device 106 may include one or more computing devices, portable computers, tablet computers, cellular phones, smartphones, wearable devices (e.g., watches, glasses, lenses, clothing, and/or the like), PDAs, and/or the like. In some non-limiting embodiments, user device 106 may interconnect (e.g., establish a connection to communicate) with merchant system 108 via wired connections, wireless connections, or a combination of wired and wireless connections. In some non-limiting embodiments, user device 106 may or may not be capable of receiving information (e.g., from merchant system 108) via a short-range wireless communication connection (e.g., a near-field communication (NFC) communication connection, an radio frequency identification (RFID) communication connection, a Bluetooth® communication connection, and/or the like) and/or communicating information (e.g., to merchant system 108) via a short range wireless communication connection.

Merchant system 108 may include one or more devices capable of receiving information from address management system 102, issuer system 104, user device 106, and/or address verification system 110 via network 112 and/or communicating information to address management system 102, issuer system 104, merchant system 108, and/or address verification system 110 via network 112. For example, merchant system 108 may include one or more computing devices, such as one or more servers, one or more client devices, one or more point-of-sale (POS) devices, and/or other like devices. In some non-limiting embodiments, merchant system 108 may include a device capable of receiving information from user device 106 via a network (e.g., network 112) and/or a wireless communication connection (e.g., an NFC communication connection, an RFID communication connection, a Bluetooth® communication connection, and/or the like) with user device 106, and/or communicating information to user device 106 via the network and/or the communication connection. In some non-limiting embodiments, merchant system 108 may be associated with a merchant as described herein. In some non-limiting embodiments, merchant system 108 may include one or more user devices 106. For example, merchant system 108 may include user device 106 that allows a merchant to communicate information to address management system 102. In some non-limiting embodiments, merchant system 108 may include one or more devices, such as computers, computer systems, and/or peripheral devices capable of being used by a merchant to conduct a payment transaction with a user. For example, merchant system 108 may include a POS device and/or a POS system.

Address verification system 110 may include one or more devices capable of receiving information from address management system 102, issuer system 104, user device 106, and/or merchant system 108 via network 112 and/or communicating information to address management system 102, issuer system 104, user device 106, and/or merchant system 108 via network 112. For example, address verification system 110 may include one or more computing devices, such as a server, a group of servers, and/or other like devices. In some non-limiting embodiments, address verification system 110 may be associated with a financial institution, a transaction service provider, and/or an issuer as described herein.

Network 112 may include one or more wired and/or wireless networks. For example, network 112 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

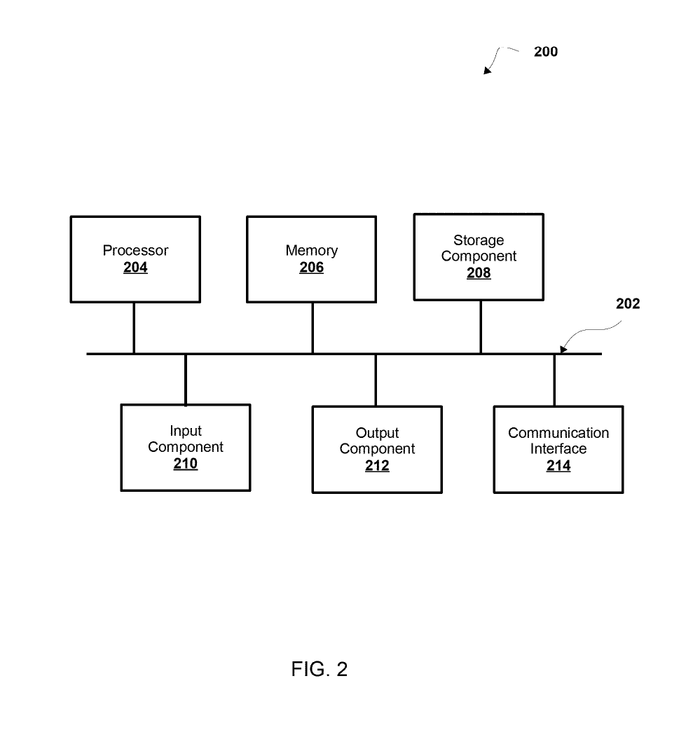

Referring now to FIG. 2, FIG. 2 is a diagram of example components of a device 200. Device 200 may correspond to address management system 102, and/or one or more devices of issuer system 104, user device 106, and/or merchant system 108. In some non-limiting embodiments, address management system 102, issuer system 104, user device 106, and/or merchant system 108 may include at least one device 200 and/or at least one component of device 200. As shown in FIG. 2, device 200 may include a bus 202, a processor 204, memory 206, a storage component 208, an input component 210, an output component 212, and a communication interface 214.

Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

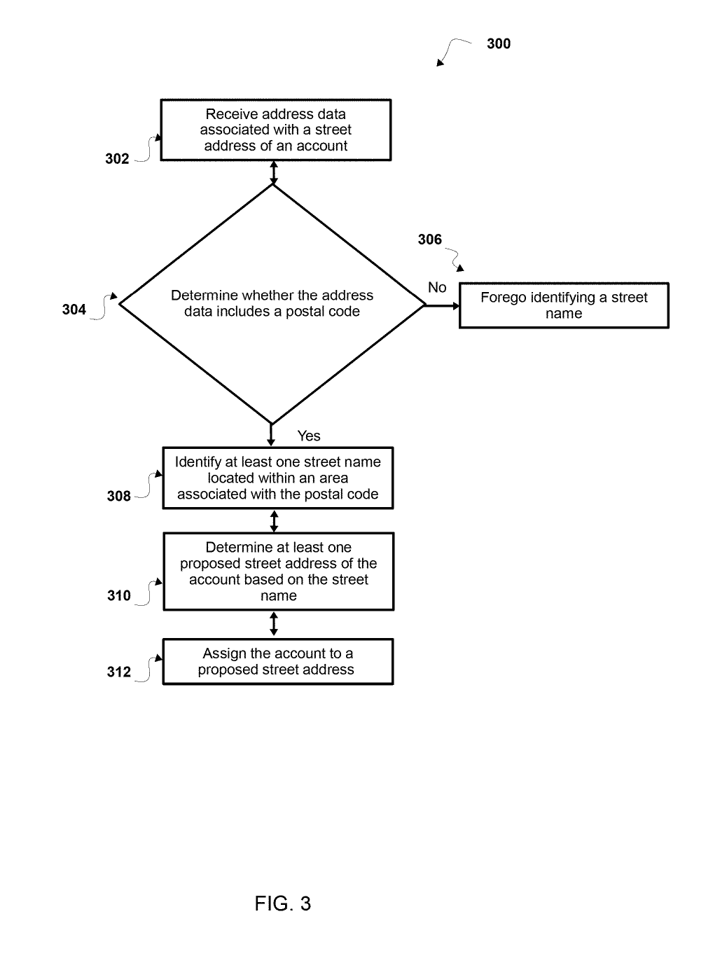

Referring now to FIG. 3, FIG. 3 is a flowchart of a non-limiting embodiment of a process 300 for determining an address associated with an account. In some non-limiting embodiments, one or more of the steps of process 300 may be performed (e.g., completely, partially, etc.) by address management system 102 (e.g., one or more devices of address management system 102). In some non-limiting embodiments, one or more of the steps of process 300 may be performed (e.g., completely, partially, etc.) by another device or a group of devices separate from or including address management system 102, such as issuer system 104 (e.g., one or more devices of issuer system 104), user device 106, merchant system 108 (e.g., one or more devices of merchant system 108), or address verification system 110.

As shown in FIG. 3, at step 302, process 300 includes receiving address data associated with a street address of an account. For example, address management system 102 may receive address data associated with an address of an account (e.g., an account associated with a payment card, a credit account, a debit account, a credit card account, a debit card account, and/or the like) based on a user associated with user device 106 conducting an online payment transaction (e.g., an ecommerce payment transaction) involving a merchant associated with merchant system 108. In some non-limiting embodiments, address management system 102 may receive the address from issuer system 104, user device 106, merchant system 108, and/or address verification system 110. For example, address management system 102 may receive the address data from issuer system 104, user device 106, merchant system 108, and/or address verification system 110 based on a user associated with user device 106 conducting an online payment transaction (e.g., an ecommerce payment transaction) involving a merchant associated with merchant system 108.

In some non-limiting embodiments, the address data associated with the street address of the account may include a street name (e.g., a name of a road, a roadway name, and/or the like) associated with the street address of the account, a street number (e.g., a building number, a house number, and/or the like) associated with the street address of the account, a postal code (e.g., a postcode, a zip code, and/or the like) associated with the street address of the account. For example, the address data associated with the street address of the account may include a street name associated with a street address of a residence of a user associated with the account, a street number associated with a street address of a residence of a user associated with the account, and/or a postal code associated with a street address of a residence of a user associated with the account. In some non-limiting embodiments, a postal code may include a five-digit postal code and/or a nine-digit postal code.

In some non-limiting embodiments, address data associated with a street address of an account may include address data associated with a street address of an account communicated by a user (e.g., communicated by user device 106 associated with a user) associated with the account during an online payment transaction involving the account. For example, the address data associated with the street address of the account may include address data associated with a street address of an account communicated by user device 106 associated with the user to a website associated with merchant system 108 during an online payment transaction between the user and a merchant associated with merchant system 108 involving the account.

In some non-limiting embodiments, address management system 102 may receive an address verification service (AVS) code. For example, address management system 102 may receive an AVS code determined by address verification system 110. In some non-limiting embodiments, the AVS code may include an indication that address data associated with a street address of an account communicated by a user during an online payment transaction corresponds to address data associated with a street address of the account stored in a data structure. In some non-limiting embodiments, the AVS code may include an indication that a postal code (e.g., a five-digit postal code, a nine-digit postal code, and/or the like) communicated by a user during an online payment transaction corresponds to a postal code stored in a data structure (e.g., a postal code stored by an issuer that issued the account in a data structure, a postal code stored by a transaction service provider associated with the account in a data structure, and/or the like), an indication that a street number communicated by a user during an online payment transaction involving the user and a merchant corresponds to a street number stored in a data structure (e.g., a street number stored by an issuer that issued the account in a data structure, a street number stored by a transaction service provider associated with the account in a data structure, and/or the like), and/or an indication that a postal code and a street number communicated by a user during an online payment transaction involving the user and a merchant corresponds to a postal code and a street number stored in a data structure (e.g., a postal code and a street number stored by an issuer that issued the account in a data structure, a postal code and a street number stored by a transaction service provider associated with the account in a data structure, and/or the like).

In some non-limiting embodiments, address verification system 110 may receive address data associated with a street address of an account and address verification system 110 may determine an AVS code based on the address data. For example, address verification system 110 may receive address data associated with a street address of an account from user device 106 associated with a user, where the user is associated with the account, during an online payment transaction involving the account associated with the user. Address verification system 110 may determine an AVS code based on the address data associated with the street address of the account received from user device 106. In some non-limiting embodiments, address verification system 110 may communicate the address data associated with the street address of the account and/or the AVS code based on determining the AVS code. For example, address verification system 110 may communicate the address data associated with the street address of the account and/or the AVS code to address management system 102 based on determining the AVS code.

In some non-limiting embodiments, address management system 102 may receive address data associated with a street address of an account and/or an AVS code from one or more computing devices. For example, address management system 102 may receive address data associated with a street address of an account and/or an AVS code from issuer system 104, user device 106, and/or merchant system 108 based on issuer system 104, user device 106, and/or merchant system 108 receiving the address data and/or the AVS code from address verification system 110.

As further shown in FIG. 3, at step 304, process 300 includes determining whether the address data associated with the street address of the account includes a postal code. For example, address management system 102 may determine whether the address data associated with the street address of the account includes a postal code.

In some non-limiting embodiments, address management system 102 may determine whether address data associated with a street address of an account includes a postal code based on an AVS code. For example, address management system 102 may receive the address data associated with the street address of the account and an AVS code. Address management system 102 may determine whether the AVS code includes an indication associated with a postal code (e.g., an indication that a postal code communicated by a user during an online payment transaction involving the user and a merchant corresponds to a postal code stored in a data structure and/or an indication that a postal code and a street number communicated by a user during an online payment transaction involving the user and a merchant corresponds to a postal code and a street number stored in a data structure). If address management system 102 determines that the AVS code includes an indication associated with a postal code, address management system 102 may determine that the address data includes a postal code. If address management system 102 determines that the AVS code does not include an indication associated with a postal code, address management system 102 may determine that the address data does not include a postal code.

In some non-limiting embodiments, address management system 102 may determine whether the address data associated with the street address of the account includes a predetermined type of postal code (e.g., a five-digit postal code, a nine-digit postal code, and/or the like) based on an AVS code. For example, address management system 102 may receive the address data associated with the street address of the account and the AVS code. Address management system 102 may determine whether the AVS code includes an indication associated with the predetermined type of postal code (e.g., an indication that a predetermined type of postal code communicated by a user during an online payment transaction involving the user and a merchant corresponds to a predetermined type of postal code stored in a data structure and/or an indication that a predetermined type of postal code and a street number communicated by a user during an online payment transaction involving the user and a merchant corresponds to a predetermined type of postal code and a street number stored in a data structure). If address management system 102 determines that the AVS code includes an indication associated with the predetermined type of postal code, address management system 102 may determine that the address data includes the predetermined type of postal code. If address management system 102 determines that the AVS code does not include an indication associated with the predetermined type of postal code, address management system 102 may determine that the address data does not include the predetermined type of postal code.

In some non-limiting embodiments, address management system 102 may determine whether the address data associated with the street address of the account includes a postal code and/or a predetermined type of postal code based on a format associated with the postal code and/or the predetermined type of postal code (e.g., a format associated with a sequence of characters of the postal code and/or the predetermined type of postal code, a format associated with a sequence of numbers of the postal code and/or the predetermined type of postal code, and/or the like). For example, address management system 102 may receive the address data associated with the street address of the account and address management system 102 may parse the address data to determine whether the address data includes the format associated with the postal code and/or the predetermined type of postal code. If address management system 102 parses the address data to determine that the format associated with the postal code and/or the predetermined type of postal code is included in the address data, address management system 102 may determine that the address data associated with the street address of the account includes a postal code and/or a predetermined type of postal code. If address management system 102 parses the address data to determine that the format associated with the postal code and/or the predetermined type of postal code is not included in the address data, address management system 102 may determine that the address data associated with the street address of the account does not include a postal code and/or a predetermined type of postal code.

As further shown in FIG. 3, at step 306, process 300 includes foregoing identifying a street name. For example, address management system 102 may forego identifying a street name based on determining that the address data does not include a postal code. In some non-limiting embodiments, address management system 102 may forego identifying a street name based on determining that the address data does not include a predetermined type of postal code. For example, address management system 102 may forego identifying a street name based on determining that the address data does not include a five-digit postal code. In some non-limiting embodiments, address management system 102 may forego identifying a street name based on determining that the address data includes a predetermined type of postal code. For example, address management system 102 may forego identifying a street name based on determining that the address data includes a nine-digit postal code.

As further shown in FIG. 3, at step 308, process 300 includes identifying a street name located within an area associated with the postal code. For example, address management system 102 may identify at least one street name located within an area associated with a postal code based on determining that the address data associated with the street address of the account includes a postal code.

In some non-limiting embodiments, address management system 102 may identify a street name located within an area associated with a postal code based on a street number and/or a street name included in address data associated with a street address of an account received by address management system 102. For example, address management system 102 may receive the address data associated with the street address of the account. Address management system 102 may determine a street number and/or a street name, and a postal code associated with the street address of the account based on the address data (e.g., a street number, a street name, and/or a postal code included in the address data associated with the street address of the account). Address management system 102 may identify a street number and/or street name located within an area associated with the postal code that corresponds to the street number and/or the street name determined based on the address data.

In some non-limiting embodiments, address management system 102 may identify a street name located within an area associated with a postal code based on determining that address data associated with a street address of an account includes a five-digit postal code. For example, address management system 102 may receive the address data associated with the street address of the account. Address management system 102 may determine a postal code associated with the street address of the account based on the address data received by address management system 102. Address management system 102 may determine that the postal code corresponds to a five-digit postal code. Address management system 102 may determine a street number associated with the street address of the account included in the address data received by address management system 102 based on determining that that the postal code associated with the street address of the account corresponds to a five-digit postal code. Address management system 102 may identify a street name located within an area associated with the postal code that corresponds to the street number included in the address data.

As further shown in FIG. 3, at step 310, process 300 includes determining at least one proposed street address of the account based on the street name located within the area associated with the postal code. For example, address management system 102 may determine at least one proposed street address (e.g., a proposed street address, a plurality of proposed street addresses, and/or the like) of the account based on the street name located within the area associated with the postal code.

In some non-limiting embodiments, address management system 102 may determine at least one proposed street address of the account that include a street name that corresponds to at least one street name identified by address management system 102 as being located within the area associated with the postal code included in address data received by address management system 102. For example, address management system 102 may receive address data associated with a street address of an account and address management system 102 may determine a street number, a street name, and a postal code associated with the street address of the account based on the address data. Address management system 102 may determine a plurality of street addresses (e.g., all street addresses) located within the area associated with the postal code that include the street name determined by address management system 102. Address management system 102 may determine the at least one proposed street address based on the plurality of street addresses located within the area associated with the postal code that include the street number and the street name determined by address management system 102.

In some non-limiting embodiments, address management system 102 may determine the at least one proposed street address of the account based on a street number, a street name, and a postal code included in address data received by address management system 102. For example, address management system 102 may receive address data associated with a street address of an account and address management system 102 may determine a street number, a street name, and a postal code associated with the street address of the account based on the address data. Address management system 102 may determine a plurality of street addresses (e.g., all street addresses) located within the area associated with the postal code that include the street name determined by address management system 102. Address management system 102 may determine the at least one proposed street address based on the plurality of street addresses located within the area associated with the postal code that include at least a portion of the street number and the street name determined by address management system 102. In some non-limiting embodiments, a street number associated with the at least one proposed street address may include at least a portion of the street number (e.g., one or more digits of the street number) of the street address associated with the account that was determined by address management system 102 based on the address data.

In some non-limiting embodiments, the at least one proposed street address of the account may include a street number associated with the at least one proposed street address, a street name associated with the at least one proposed street address, and/or a secondary address unit designator (e.g., an apartment number, a suite number, and/or the like) associated with the at least one proposed street address. In some non-limiting embodiments, the at least one proposed street address of an account may include one or more street addresses located within an area associated with a postal code included in the address data associated with a street address of the account received by address management system 102.

As further shown in FIG. 3, at step 312, process 300 includes assigning the account to a proposed street address. For example, address management system 102 may assign the account to a proposed street address of the at least one proposed street address. In some non-limiting embodiments, address management system 102 may assign the account to a proposed street address based on determining whether the proposed street address is associated with a residential household. For example, if address management system 102 determines that the proposed street address is associated with a residential household, address management system 102 may assign the account to the proposed street address. If address management system 102 determines that the proposed street address is not associated with a residential household, address management system 102 may forego assigning the account to the proposed street address.

In some non-limiting embodiments, address management system 102 may assign the account to a proposed street address of a plurality of proposed street addresses based on a criteria associated with the proposed street address. For example, address management system 102 may assign the account to a proposed street address of the at least one proposed street address based on the proposed street address being associated with a residential household (e.g., a residential household and not a commercial establishment, the proposed street address being associated with a plurality of residential households (e.g., the proposed street address being associated with an apartment building including a plurality of residential rental units), the proposed street address being located within a predetermined distance of a location of a merchant (e.g., a merchant involved in a payment transaction that was conducted using an account identifier associated with the account, a merchant involved in a plurality of payment transactions that were conducted using an account identifier associated with the account, a merchant of a plurality of merchants involved in maximum number of payment transactions of a plurality of payment transactions involving the plurality of merchants that were conducted using an account identifier associated with the account, and/or the like), and/or the proposed street address being located within a predetermined distance of a location of a financial institution (e.g., a location of a financial institution of a plurality of locations of the financial institution involved in maximum number of financial transactions of a plurality of financial transactions involving the plurality of locations of the financial institution that were conducted using an account identifier associated with the account, a location of a financial institution of a plurality of locations of the financial institution most frequently involved in financial transactions that were conducted using an account identifier associated with the account, a location of a financial institution of a plurality of locations of the financial institution most frequently involved in fund withdrawals that were conducted using an account identifier associated with the account, and/or the like).

In some non-limiting embodiments, address management system 102 may assign the account to a proposed street address of a plurality of proposed street addresses based on a status of the proposed street address associated with the proposed street address. For example, address management system 102 may assign the account to the proposed street address of the plurality of proposed street addresses based on the proposed street address being associated with a status of a residential household (e.g., the proposed street address is classified as having a status associated with a residential household).

In some non-limiting embodiments, address management system 102 may assign the account to a proposed street address of a plurality of proposed street addresses based on a logical operation. For example, address management system 102 may assign the account to the proposed street address of the plurality of proposed street addresses by performing a logical operation (e.g., a modulo operation, a hashing operation, and/or the like) on an account identifier associated with an account and assigning the account to the proposed street address of the plurality of proposed street addresses based on the result of the logical operation. In some non-limiting embodiments, address management system 102 may assign a first account of a plurality of accounts to a first proposed street address of a plurality of proposed street addresses based on performing a logical operation on a first account identifier of the first account. Additionally or alternatively, address management system 102 may assign a second account of the plurality of accounts to a second proposed street address of the plurality of proposed street addresses based on performing the logical operation on a second account identifier of the second account.

In some non-limiting embodiments, address management system 102 may communicate assignment data associated with an assignment of the account to the proposed street address. For example, address management system 102 may communicate assignment data associated with an assignment of the account to the proposed street address based on assigning the account to the proposed street address.

In some non-limiting embodiments, address management system 102 may determine a postal code of a proposed street address based on assigning an account to the proposed street address. For example, address management system 102 determines a nine-digit postal code of a proposed street address based on assigning an account to the proposed street address.

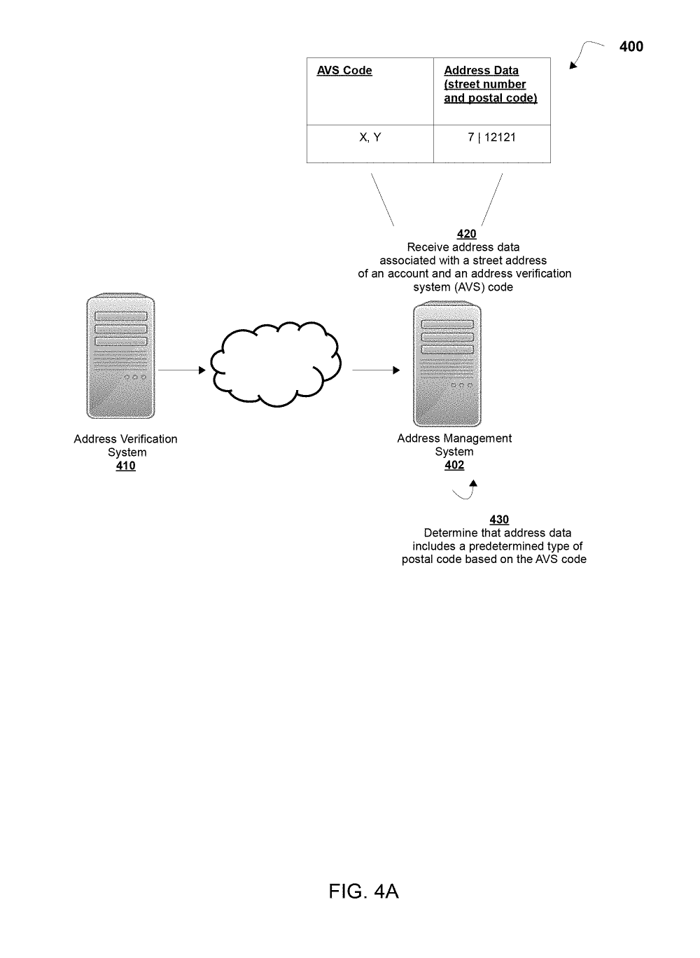

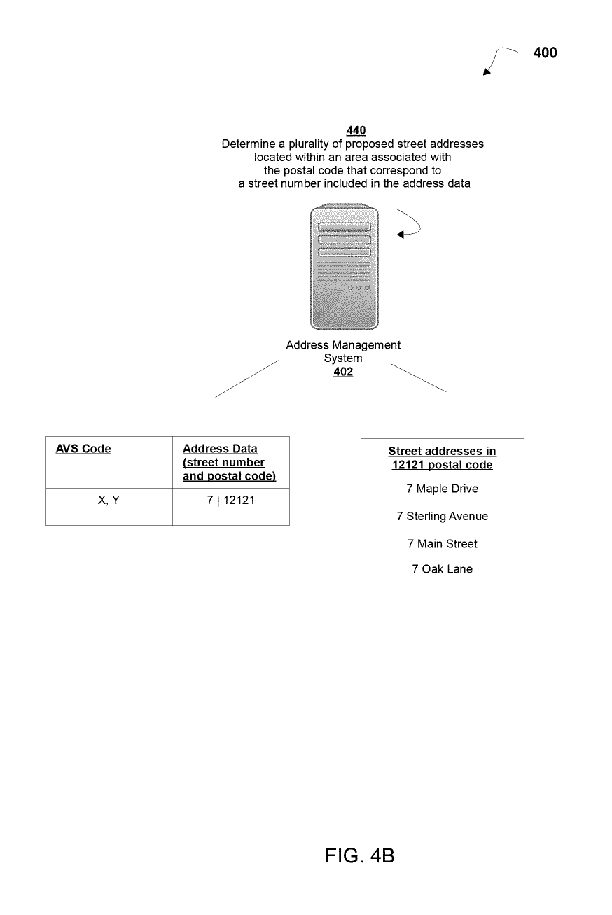

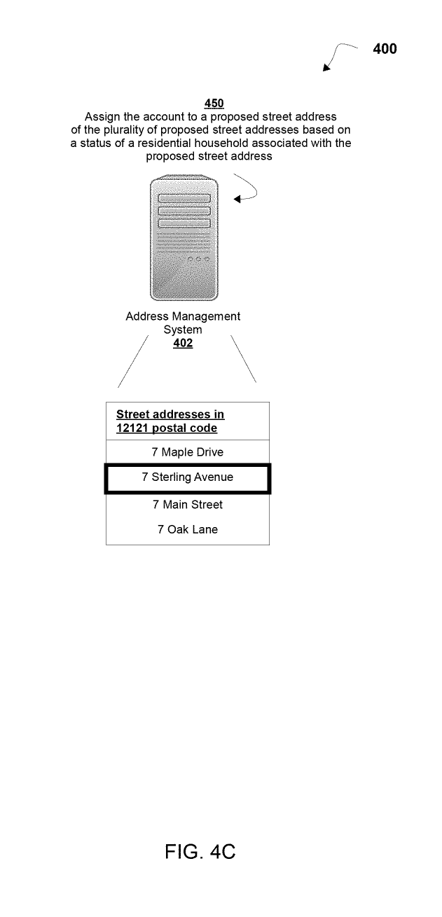

FIGS. 4A-4C are diagrams of an overview of a non-limiting embodiment of an implementation 400 relating to process 300 shown in FIG. 3. As shown in FIGS. 4A-4C, implementation 400 may include address management system 402 and address verification system 410. In some non-limiting embodiments, address management system 402 may be the same or similar to address management system 102, and address verification system 410 may be the same as or similar to address verification system 110 as described above.

As shown by reference number 420 in FIG. 4A, address management system 402 may receive address data associated with a street address of an account and an AVS code. In some non-limiting embodiments, address verification system 410 may communicate the address data associated with the street address of the account and the AVS code to address management system 402. For example, address verification system 410 may communicate the address data associated with the street address of the account and the AVS code to a computing device via a network and the computing device may receive the address data associated with the street address of the account and the AVS code and communicate the address data associated with the street address of the account and the AVS code to address management system 402.

As further shown by reference number 430 in FIG. 4A, address management system 402 may determine that the address data associated with the street address of the account includes a predetermined type of postal code (e.g., a five-digit postal code, a nine-digit postal code, and/or the like) based on the AVS code. For example, address management system 402 may determine that the address data associated with the street address of the account includes a five-digit postal code based on an indication included in the AVS code.

As shown by reference number 440 in FIG. 4B, address management system 402 may determine a plurality of proposed street addresses located within an area associated with a postal code that correspond to a street number included in the address data (e.g., a plurality of proposed street addresses located within an area associated with a postal code that include a street number included in the address data). For example, address management system 102 may determine a street number and a postal code of the street address of the account included in the address data received by address management system 102. Address management system 102 may determine a plurality of proposed street addresses located within an area associated with the postal code that include the street number of the street address of the account.

As shown by reference number 450 in FIG. 4C, address management system 402 may assign the account to a proposed street address of the plurality of proposed street addresses based on a status of the proposed street address associated with the proposed street address. For example, address management system 402 may assign the account to a proposed street address of the plurality of proposed street addresses based on the proposed street address being associated with a status of a residential household (e.g., the proposed street address is classified as having a status associated with a residential household). In some non-limiting embodiments, address management system 102 may determine a nine-digit postal code associated with the proposed street address based on assigning the account to the proposed street address and communicate the nine-digit street address to a computing device.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A method for determining a street address associated with an account, comprising:
receiving, with at least one processor, address data associated with a street address of an account, wherein the address data comprises a street number of the street address and a postal code of the street address;
determining, with at least one processor, whether the address data associated with the street address of the account includes a postal code;
identifying, with at least one processor, at least one street name located within an area associated with the postal code of the street address based on determining that the address data associated with the street address of the account includes a postal code;
determining, with at least one processor, at least one proposed street address based on the street name located within the area associated with the postal code of the street address; and
assigning, with at least one processor, the account to a proposed street address of the at least one proposed street address based on a criteria associated with the proposed street address.

2. The method of claim 1, further comprising:
receiving address verification system (AVS) code data associated with an AVS code, wherein the AVS code is associated with an online payment transaction involving the account; and
wherein determining whether the address data associated with the street address of the account includes a postal code comprises:
determining whether the AVS code data associated with the AVS code indicates that the address data associated with the street address of the account includes a postal code.

3. The method of claim 2, wherein identifying the street name located within the area associated with the postal code of the street address comprises:
identifying the street name located within the area associated with the postal code of the street address based on determining that the AVS code data associated with the AVS code indicates that the address data associated with the street address of the account includes a postal code.

4. The method of claim 1, further comprising:
communicating assignment data associated with an assignment of the account to the proposed street address based on assigning the account to the proposed street address.

5. The method of claim 1, wherein assigning the account to the proposed street address comprises:
assigning the account to the proposed street address of the at least one proposed street address based on a number of residential households associated with the proposed street address.

6. The method of claim 1, wherein assigning the account to the proposed street address of the at least one proposed street address based on the criteria associated with the proposed street addresses comprises:
determining whether the proposed street address of the at least one proposed street address is associated with a residential household; and
assigning the account to the proposed street address of the at least one proposed street address based on determining that the proposed street address of the at least one proposed street address is associated with a residential household.

7. The method of claim 1, wherein the at least one proposed street address are a plurality of proposed street addresses and wherein assigning the account to the proposed street address of the plurality of proposed street addresses comprises:
assigning the account to the proposed street address of the plurality of proposed street addresses based on the proposed street address being located within a predetermined distance of a location of a merchant.

8. A system for determining a street address associated with an account comprising:
at least one processor programmed or configured to:
receive address data associated with a street address of an account, wherein the address data comprises a street number of the street address and a postal code of the street address;
determine that the address data associated with the street address of the account includes a postal code;
identify at least one street name located within an area associated with the postal code of the street address based on determining that the address data associated with the street address of the account includes a postal code;
determine a plurality of proposed street addresses based on the at least one street name located within the area associated with the postal code of the street address; and
assign the account to a proposed street address of the plurality of proposed street addresses.

9. The system of claim 8, wherein the at least one processor is further programmed or configured to:
determine a distance between a location of a merchant and each of the plurality of proposed street addresses; and
assigning the account to the proposed street address of the plurality of proposed street addresses based on the distance between the location of the merchant and the proposed street address satisfying a threshold value of a distance.

10. The system of claim 8, wherein the at least one processor is further programmed or configured to:
receive address verification system (AVS) code data associated with an AVS code, wherein the AVS code is associated with an online payment transaction involving the account; and
wherein, when determining whether the address data associated with the street address of the account includes a postal code, the at least one processor is programmed or configured to:
determine whether the AVS code data associated with the AVS code indicates that the address data associated with the street address of the account includes a postal code.

11. The system of claim 10, wherein, when identifying the street name located within the area associated with the postal code of the street address, the at least one processor is programmed or configured to:
identify the street name located within the area associated with the postal code of the street address based on determining that the AVS code data associated with the AVS code indicates that the address data associated with the street address of the account includes a postal code.

12. The system of claim 8, wherein the at least one processor is further programmed or configured to:
determine a nine-digit postal code associated with the proposed street address based on assigning the account to the proposed street address; and
communicate data associated with the nine-digit postal code to a computing device.

13. The system of claim 8, wherein assigning the account to the proposed street address comprises:
assigning the account to the proposed street address of the plurality of proposed street addresses based on a number of residential households associated with the proposed street address.

14. The system of claim 8, wherein assigning the account to the proposed street address of the plurality of proposed street addresses comprises:
determining whether the proposed street address of the plurality of proposed street addresses is associated with a residential household; and
assigning the account to the proposed street address of the plurality of proposed street addresses based on determining that the proposed street address of the plurality of proposed street addresses is associated with a residential household.

15. The system of claim 8, wherein, when assigning the account to the proposed street address of the plurality of proposed street addresses, the at least one processor is programmed or configured to:
assign the account to the proposed street address of the plurality of proposed street addresses based on the proposed street address being located within a predetermined distance of a location of a merchant.

16. A computer program product for determining a street address associated with an account, the computer program product comprising at least one non-transitory computer-readable medium including one or more instructions that, when executed by at least one processor, cause the at least one processor to:
receive address data associated with a street address of an account and AVS code data associated with an AVS code;
determine whether the address data associated with the street address of the account includes a postal code based on the AVS code data associated with the AVS code;
determine a postal code of the street address of the account based on determining that the address data associated with the street address of the account includes a postal code;
identify at least one street name located within an area associated with the postal code of the street address based on determining the postal code of the street address of the account, wherein the one or more instructions that cause the at least one processor to identify the street name located within the area associated with the postal code of the street address, cause the at least one processor to identify the at least one street name based on a street number and a postal code included in the address data associated with the street address of the account;
determine a plurality of proposed street addresses based on the street name located within the area associated with the postal code of the street address; and
assign the account to a proposed street address of the plurality of proposed street addresses based on the proposed street address of the plurality of proposed street addresses being associated with a residential household.

17. The computer program product of claim 16, wherein the one or more instructions further cause the at least one processor to:
determine a distance between a location of a merchant and each of the plurality of proposed street addresses; and
assign the account to the proposed street address of the plurality of proposed street addresses based on the distance between the location of the merchant and the proposed street address that satisfies a threshold value of a distance.

18. The computer program product of claim 16, wherein the one or more instructions further cause the at least one processor to:
determine whether the AVS code data associated with the AVS code indicates that the address data associated with the street address of the account includes a postal code.

19. The computer program product of claim 16, wherein the one or more instructions that cause the at least one processor to identify the street name located within the area associated with the postal code of the street address, cause the at least one processor to:
identify the street name located within the area associated with the postal code of the street address based on determining that the AVS code data associated with the AVS code indicates that the address data associated with the street address of the account includes a postal code.

20. The computer program product of claim 16, wherein the one or more instructions further cause the at least one processor to:
determine a nine-digit postal code associated with the proposed street address based on assigning the account to the proposed street address; and
communicate data associated with the nine-digit postal code to a computing device.
